(19) United States
(12) Patent Application Publication
(10) Pub. No.: US 2025/0331075 A1
(43) Pub. Date: Oct. 23, 2025

(54) METHOD FOR STIMULATING HYDRATE DISSOCIATION USING FREQUENCY MODULATED MICROWAVES AND MICROWAVE GENERATING DEVICE

(71) Applicant: PETRÓLEO BRASILEIRO S.A. - PETROBRAS, Rio de Janeiro (BR)

(72) Inventor: Joselito Barbosa Maciel, Rio de Janeiro (BR)

(21) Appl. No.: 19/181,002

(22) Filed: Apr. 16, 2025

(30) Foreign Application Priority Data
Apr. 22, 2024 (BR) BR 1020240078543

(51) Int. Cl. E21B 41/00; E21B 43/24

(52) U.S. Cl. CPC E21B 41/0099; E21B 43/2401

(57) ABSTRACT

The present invention discloses methods and apparatus for dissociating hydrates obstructing a pipeline. Energy in the form of microwaves is supplied to the hydrate, wherein the frequency of the microwaves is varied within a predetermined range rather than a single fixed frequency. Thus, the optimum frequency, i.e., that which provides the greatest possible transfer of energy to the water, considering the temperature, pressure and type of hydrate in each particular application, is scanned and the effectiveness and efficiency of the operation is improved. The range preferably encompasses the largest possible number of statistically significant optimum frequencies considering the various operating ranges of the pipeline and various possible types of hydrates. In another aspect, an initial step is provided where an exploratory scan is performed to determine what the specific optimum frequency is for an application. Then the frequency of the microwaves is adjusted and fixed at the determined specific optimum frequency. Also disclosed is a microwave generating device for performing the frequency range scanning.

### FIELD OF THE INVENTION

The present invention is part of the field of petroleum engineering. specifically, the present invention is related to a method and device for removing hydrates that are formed in pipelines that transport oil and gas.

### BACKGROUND OF THE INVENTION

Hydrate formation is a recurring problem in oil production units. Hydrates are formed when hydrocarbons and water come into contact under conditions of high pressure and low temperatures, generally with pressures in the range of 200 kgf/cm² or more, and temperatures of 5° C. or less. The formation of a large amount of hydrates can cause the complete blockage of gas or oil transport pipelines, causing stoppages and/or production losses.

A series of procedures can be used to eliminate hydrates formed in pipelines. An example of a procedure normally used to dissociate hydrates is the depressurization of the blocked pipeline. With the pipeline depressurized, the hydrate begins to slowly dissociate. A disadvantage of this solution is the need to completely stop production for a sufficient amount of time for the hydrate to dissociate naturally, which causes loss of profit.

Another example is the passage of a PIG for mechanical removal of the hydrate. However, this technique is only possible when the pipeline is not completely blocked. In addition, the passage of the PIG also involves a stoppage in operation, in addition to the costs related to the transportation and use of the PIG.

A third example of a procedure known in the state of the art is the Nitrogen Generator System (NGS). In this technique, chemical products are injected into the obstructed pipeline that react with each other, producing a lot of heat. Heating the hydrate causes it to dissociate, since, as already mentioned, hydrates are only stable at high pressures and low temperatures.

These three exemplary procedures typically take days to eliminate the hydrates present in the pipelines, which generates losses in lost profits in addition to the costs inherent in the operation of each of these techniques. Therefore, there is a need for effective and rapid methods of eliminating hydrates that do not also involve interruption in production.

### STATE OF THE ART

The document WO 0150819 A from the state of the art, entitled “Microwave heating system for gas hydrate removal or inhibition in a hydrocarbon pipeline”, discloses a microwave heating system comprising a microwave generator, a fluid pipeline having an upstream section and a downstream section, and a waveguide assembly connected to the microwave generator. The waveguide assembly includes a microwave transition body and a microwave distributor. The microwave distributor is positioned in the fluid piping at a junction between the upstream section and the downstream section such that the microwave distributor is in contact with fluids flowing through the junction from the upstream section to the downstream section. The upstream section has a circular internal configuration with a substantially continuous open cross-section proximal to the junction. The microwave distributor is in substantially straight-line alignment with the upstream section near the junction, while the downstream section is in substantially right-angle alignment with the upstream section near the junction. The microwave transition body is positioned between the microwave generator and the microwave distributor and shapes the propagation pattern of microwave signals transmitted by the microwave generator to the internal configuration of the upstream section.

The document US 2017122476 A1 from the state of the art, entitled “Microwave-based fluid conduit heating system and method of operating the same”, discloses a fluid conduit heating system including a fluid transport conduit including a wall including a radially inner surface and a radially outer surface. The radially inner surface has a predetermined topography, and the fluid transport conduit is configured to transport a hydrocarbon fluid therethrough. The system also includes a microwave heating device in radio frequency (RF) communication with the fluid transport conduit. The microwave heating device includes a microwave generator configured to generate microwave radiation and a waveguide coupled to the microwave generator. The waveguide is configured to conform a propagation pattern of microwave radiation generated by the microwave generator to the predetermined topography of the radially inner surface.

### SUMMARY OF THE INVENTION

The present invention proposes a method for dissolving hydrates using electromagnetic waves in the microwave range, wherein the frequency of the microwaves is varied within a predetermined frequency range that includes one or more optimal frequencies, wherein the optimal frequency depends on the temperature and pressure conditions and the type of hydrate, in order to transfer the greatest possible amount of energy to the hydrate. The frequency range can be scanned continuously at any rate of variation or discontinuously. A microwave generating device that performs the microwave frequency scan according to the method is also provided.

### BRIEF DESCRIPTION OF THE DRAWINGS

The present invention will be described below with reference to typical embodiments thereof and also with reference to the attached drawings.

FIG. 1 is a representation of a triangular waveform representing the frequency scan according to the present invention.

FIG. 2 is a representation of sawtooth waveform representing the frequency scan in accordance with the present invention.

FIG. 3 is a schematic representation of the device of the present invention being implemented.

FIG. 4 shows common types of Hydrates from the state of the art, obtained from the Book Nature, Volume 426, publication Nov. 20, 2003.

### DETAILED DESCRIPTION OF THE INVENTION

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system-related and business constraints, which may vary from one implementation to another. Furthermore, it should be appreciated that such a development effort may be complex and time-consuming but would nevertheless be a routine design and manufacturing undertaking for those of ordinary skill having the benefit of this disclosure.

As is known in the art, the so-called microwaves can be used for heating several products, depending on their frequency. At ambient conditions (1 atm and 30° C.), the frequency of 2450 MHz (122 mm wavelength) has good absorption for the water molecule. Therefore, this is the microwave frequency used in domestic and industrial microwave ovens.

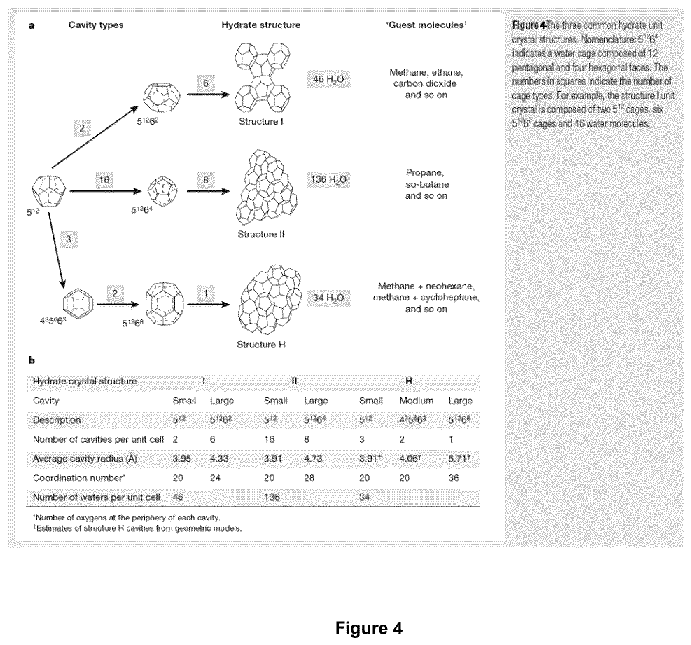

The use of microwaves for hydrate dissolution is known in the art, as seen in the documents WO 0150819 A and US 2017122476 A1. The works from the literature show microwave systems with a fixed frequency of 2450 MHz for the reason explained above. However, the optimum frequency of microwave absorption by the water molecule varies according to the pressure and temperature conditions, in addition to the specific type of hydrate, FIG. 4, which also influences this frequency. The closer the frequency of the microwaves emitted is to this optimum absorption frequency, the greater the absorption of energy by the water and, consequently, the greater the transmission of heat to the hydrate. Adjusting the microwave frequency to the optimum frequency leads to a significant increase in the efficiency and effectiveness of hydrate dissolution.

Thus, the present invention proposes scanning a predetermined microwave frequency range instead of a single frequency to dissolve hydrates obstructing pipes. For example and without limitation, the frequency range may go from 2350 MHz to 2550 MHz, being scanned continuously from its lowest point to the highest point and then returning from the highest point to the lowest point, resulting in a graph of frequency variation over time similar to a triangular waveform as seen in FIG. 1. Preferably, the frequency range will be wide enough to encompass as many frequencies as possible that can be considered optimal for several operating points. For example, the study of a given pipeline may determine that the optimal absorption frequencies for this pipeline are 2350 MHz, 2400 MHz, 2500 MHz and 2550 MHz, considering the possible combinations of temperature, pressure and hydrate type for this pipeline.

At the same time, preferably, the frequency range should be narrow enough to encompass only statistically significant frequencies, that is, those that are likely to occur in a significant amount of time, for example, more than 80% of the operating time. In an exemplary embodiment, the statistically significant optimal absorption frequencies for a given pipeline may be 2350 MHz, 2400 MHz, 2500 MHz and 2550 MHz, with other optimal frequencies, for example, 2200 MHz and/or 2600 MHz, also being possible but being statistically less significant, that is, they occur in a very small part of the time compared to the statistically significant frequencies, for example, less than 20% of the time. In this way, the frequency scan passes mainly through optimal frequencies that have a high chance of occurring, making the dissolution of the hydrate more efficient and effective.

Additionally, the frequency range must also respect the reflection limits of the medium where it will be propagated in order to allow reflection of a significantly high portion of the microwaves so that sufficient energy reaches the hydrate. For this, factors such as, for example, the diameter of the duct, thickness of the duct, material of the duct, characteristics of the multiphase medium (mixture of water and/or gas and/or oil), duct curves, distance from the point of generation of the waves to the hydrate and angle of entry of the microwaves must be taken into account when determining the frequency range. The calculations involved in determining the microwave frequencies that produce satisfactory reflection and energy transmission are complex, however, they are common knowledge in the literature. For this reason, they will not be detailed here.

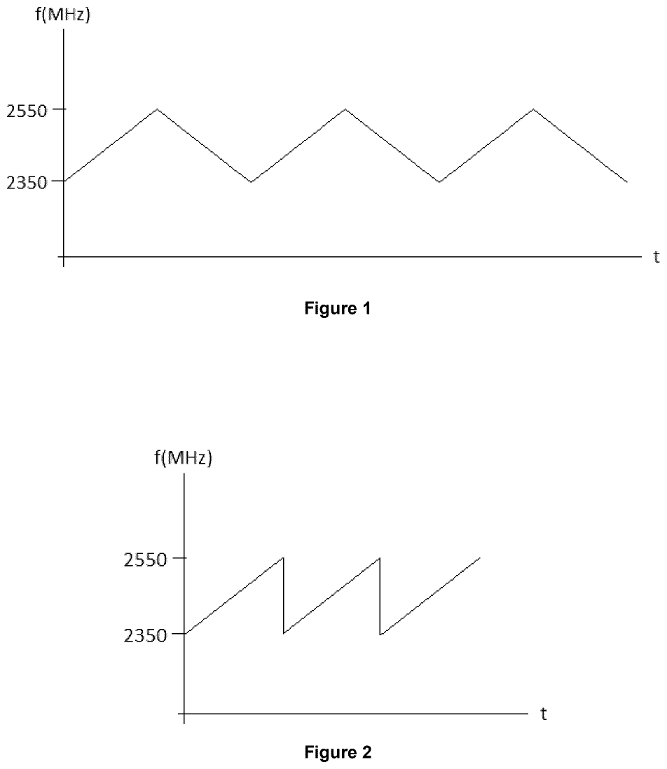

Optionally, the frequency range can be scanned starting from the lowest frequency in the range and, upon reaching the highest frequency, instantly returning to the lowest frequency, resulting in a graph of frequency variation over time similar to a sawtooth waveform, as seen in FIG. 2.

It will be appreciated that the exemplary embodiments indicated above and illustrated in FIG. 1 and FIG. 2 are not limiting. For example, the frequency range scan may be initiated at any point in said range and may scan frequencies from a lower frequency to a higher frequency or vice versa in the case of FIG. 2. Other types of scanning not explained herein are also possible without departing from the scope of the present invention.

The frequency variation may be made at any rate that the person skilled in the art deems pertinent for a specific application. For example, the microwave frequency may be varied at a rate of 1 Hz/s, 1 kHz/s, 1 MHz/s or any other rate considered convenient without departing from the scope of the present invention. Obviously, this rate becomes different at the instant when the frequency must vary instantaneously as a discontinuity, in the case of FIG. 2. In certain embodiments the frequency rate variation may vary within a scan cycle. For example, the frequency rate change may be, for example, 1 kHz/s in a first part of the scan cycle and may be, for example, 1 MHz/s in a second part of the scan cycle.

Therefore, based on the above disclosure, in a first aspect of the present invention there is provided a method of hydrate dissociation, comprising the steps of:
a) supplying electromagnetic energy in the form of microwaves to a hydrate;
b) varying the frequency of the microwaves within a predetermined range of frequencies.

In a second aspect of the invention, the method of stimulating hydrate dissociation comprises an additional step where an initial exploratory scan is performed to determine the optimum absorption frequency for the present combination of temperature, pressure and hydrate type, i.e., the frequency that will transfer the greatest possible amount of energy to the water. The exploratory scan may follow the scanning logic as disclosed in relation to FIG. 1, or FIG. 2 or any other logic that the skilled person deems convenient. After this determination is made, the microwave generating device is adjusted to the optimum absorption frequency, which is supplied to the hydrate. According to the second aspect of the present invention, a hydrate dissociation method comprises the steps of:
a) supplying electromagnetic energy in the form of microwaves to a hydrate during an exploratory scan, wherein the frequency of the microwaves is varied within a predetermined range of frequencies;
b) determining an optimum absorption frequency based on data obtained from the hydrate;
c) supplying electromagnetic energy in the form of microwaves to the hydrate at a frequency equal to the determined optimum absorption frequency.

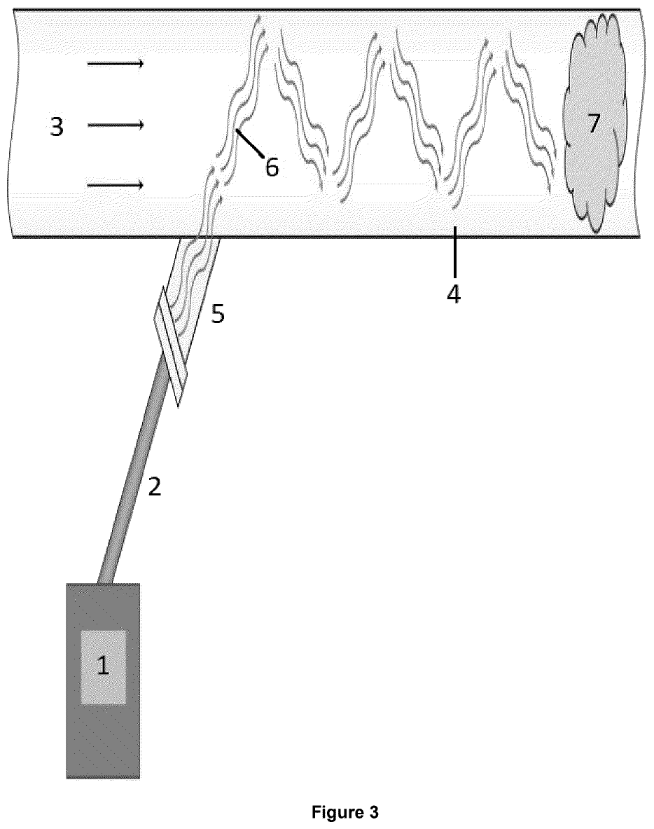

In a third aspect of the present invention, a microwave generating device 1 capable of varying the frequency of the microwaves within a predetermined range is provided. The device 1 may be a microwave generating valve (Magnetron or Klystron) or a solid state microwave generating circuit with frequency modulation. The device is positioned as seen in the diagram illustrated in FIG. 3, where the device 1 is coupled to the duct 4 by means of a spool 5 through its waveguide 2. The microwaves 6 are generated from the device 1 and travel inside the duct 2 by reflection from its internal walls without the need to interrupt the multiphase flow of water and/or oil and/or gas 3 inside the duct 2, until reaching the hydrate 7. According to the present invention, the frequency of the microwaves 6 is varied within a predetermined range of frequencies to cause the dissociation of the hydrate 7 according to the method of the first aspect of the invention. Alternatively, variation of the frequencies of the microwaves 6 is performed during an exploratory scan to determine the optimum absorption frequency, after which the generation frequency of the microwaves 6 is adjusted in the device 1 to be equal to the determined optimum frequency, in accordance with the method of the second aspect of the present invention.

This device will be coupled to the duct, FIG. 3, so that the microwaves generated can be directed to the focal point of the hydrate which is in the duct.

Although aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is intended to cover all modifications, equivalents and alternatives that fall within the scope of the invention as defined by the following appended claims.

1. A method for stimulating hydrate dissociation, comprising the steps of:
a) supplying electromagnetic energy in the form of microwaves to a hydrate; and
b) varying the frequency of the microwaves within a predetermined frequency range.

2. The method, according to claim 1, wherein the microwave frequency is varied continuously or discontinuously.

3. The method, according to claim 1, wherein the variation of the microwave frequency follows a triangular waveform.

4. The method, according to claim 1, wherein the variation of the microwave frequency is carried out at a rate of 1 Hz/s, 1 kHz/s, or 1 MHz/s.

5. The method, according to claim 1, wherein the variation of the microwave frequency follows a sawtooth waveform.

6. A method for dissolving a hydrate, comprising the steps of:
a) supplying electromagnetic energy in the form of microwaves to a hydrate during an exploratory scan, wherein the frequency of the microwaves is varied within a predetermined range of frequencies;
b) determining an optimal absorption frequency based on data obtained from the hydrate; and
c) supplying electromagnetic energy in the form of microwaves to the hydrate at a frequency equal to the determined optimal absorption frequency.

7. The method, according to claim 6, wherein varying the frequency of the microwaves during the exploratory scan is done continuously.

8. The method, according to claim 6, wherein the variation of the frequency of the microwaves during the exploratory scan follows a triangular waveform.

9. The method, according to claim 6, wherein the variation of the microwave frequency during the exploratory scan is made at a rate of 1 Hz/s, 1 kHz/s, or 1 MHz/s.

10. The method, according to claim 6, wherein the variation of the microwave frequency during the exploratory scan follows a sawtooth waveform.

11. A microwave generating device, configured to vary the microwave frequency within a predetermined frequency range.

12. The device, according to claim 11, wherein the device is further configured to vary the microwave frequency in a continuous manner.

13. The device, according to claim 11, wherein the device is further configured to vary the microwave frequency so as to follow a triangular waveform.

14. The device, according to claim 11, wherein the device is further configured to vary the frequency of the microwaves at a rate of 1 Hz/s, 1 kHz/s, or 1 MHz/s.

15. The device, according to claim 11, wherein the device is further configured to vary the frequency of the microwaves so as to follow a sawtooth waveform.

16. The device, according to claim 11, wherein the device is a Magnetron or Klystron microwave generating valve, or a solid state microwave generating circuit with frequency modulation.
